(19) United States
(12) Patent Application Publication
(10) Pub. No.: US 2010/0277917 A1
(43) Pub. Date: Nov. 4, 2010

(54) ELECTRICALLY INSULATED LED LIGHTS

(76) Inventor: Xinxin Shan, Edmonton (CA)

Correspondence Address: Zarian Midgley & Johnson PLLC, University Plaza, 960 Broadway Ave., Suite 250, Boise, ID, 83706, US

(21) Appl. No.: 12/434,405

(22) Filed: May 1, 2009

(51) Int. Cl. F21V 21/00

(52) U.S. Cl. 362/249.02; 362/362

(57) ABSTRACT

A method of electrical insulation used in the high voltage (>60V) LED lighting system. The LED lighting system comprises the housing, end cap, lens and PCBs. The LEDs are mounted on the PCBs. The insulating housing or channel between the PCBs and the housing prevents the electrical shock and increase the clearance and creepage distance. The insulating housing or channel is made of materials with good heat conductivity and high insulation.

### TECHNICAL FIELD

The present method relates in particular to a high voltage (>60V) LED (light emitting diode) lighting system.

### BACKGROUND

In lots of the applications of LED lighting system, the housing of the light uses metals, like aluminum, steel, etc., to improve the heat dissipation efficiency. As an electrical conductive material, the metal housing might cause electrical leakage or shock. In addition, due to the very limited space in the LED products, it is very hard to meet the requirements of the creepage and the clearance distance. When the PCBs are installed in the metal housing and the operational voltage of the LED lighting system is higher than 60 volts, the lights might cause the danger.

### SUMMARY

There is provided a method to insulate the PCBs of an LED lighting system from an electrically conductive housing. Also, the design of the system provides good heat conductivity to transfer the heat from the PCBs to the metal housing. There is thus provided a separator between the PCBs and the electrical conductive housing. The separator is fitted to the housing, which may be of various shapes. Thus, in one embodiment there is provided an LED lighting system, comprising a housing, a circuit board carrying one or more LEDs; and a separator between the housing and circuit board, the separator being electrically insulating relative to the housing and thermally conductive relative to air.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIGS. 1A and 1B are respectfully a sectional and perspective view of a LED tube light with an insulating channel.

FIGS. 2A and 2B are respectfully a sectional and perspective view of a LED round light with an insulating housing or channel. The insulating housing or channel goes through the hole on the bottom of the housing.

FIGS. 3A and 3B are respectfully a sectional and perspective view of a LED round light with an insulating housing or channel. The insulating housing or channel does not go through the hole on the bottom of the housing.

FIGS. 4A and 4B are respectfully a sectional and perspective view of a LED round light with the wires on the top of the insulating housing or channel.

FIGS. 5A and 5B are respectfully a sectional and perspective view of a LED round light with the wires going through the hole on the side of the insulating housing or channel.

FIGS. 6A and 6B are respectfully a sectional and perspective view of a LED round light with the wire going through the ‘U’ shape slot on the side of the insulating housing or channel.

### DETAILED DESCRIPTION

The basic configuration, shown in each figure, is an LED lighting system, comprising a housing, a circuit board (PCB board for example) carrying one or more LEDs; and a separator between the housing and circuit board, the separator being electrically insulating relative to the housing and thermally conductive relative to air. That is, the separator is less electrically conductive than the housing and more thermally conductive than air. Preferably, the separator conforms to the shape of the housing. The terms electrically insulating and thermally conductive refer to the property of the material for each unit of thickness. By air is meant air at atmospheric pressure, 50% relative humidity and 20° C.

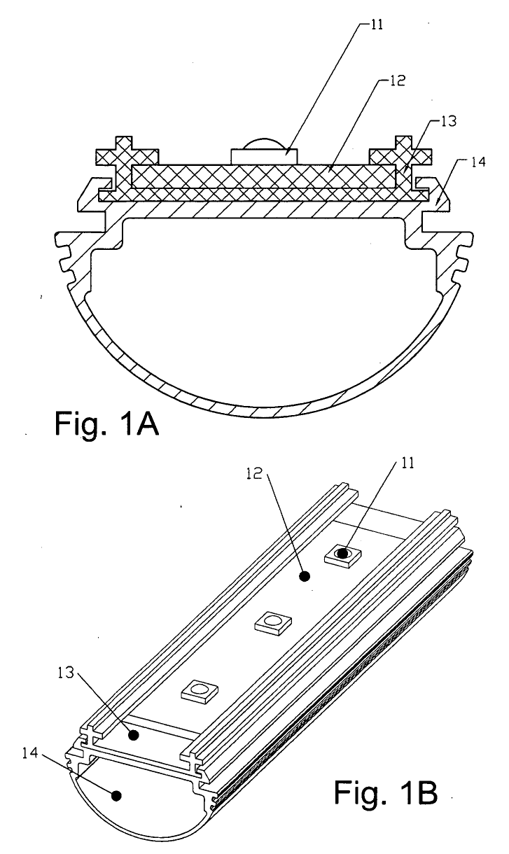

FIGS. 1A and 1B show a LED tube light with the present insulation method. LEDs 11 are mounted on the PCB 12. The housing 14 is made of metal, such as aluminum, to dissipate the heat. The separator in this case is an insulating channel 13 installed between the PCB 12 and the housing 14. The shape of the insulating material 13 is a channel along the housing 14 with complementary shape to the housing 14.

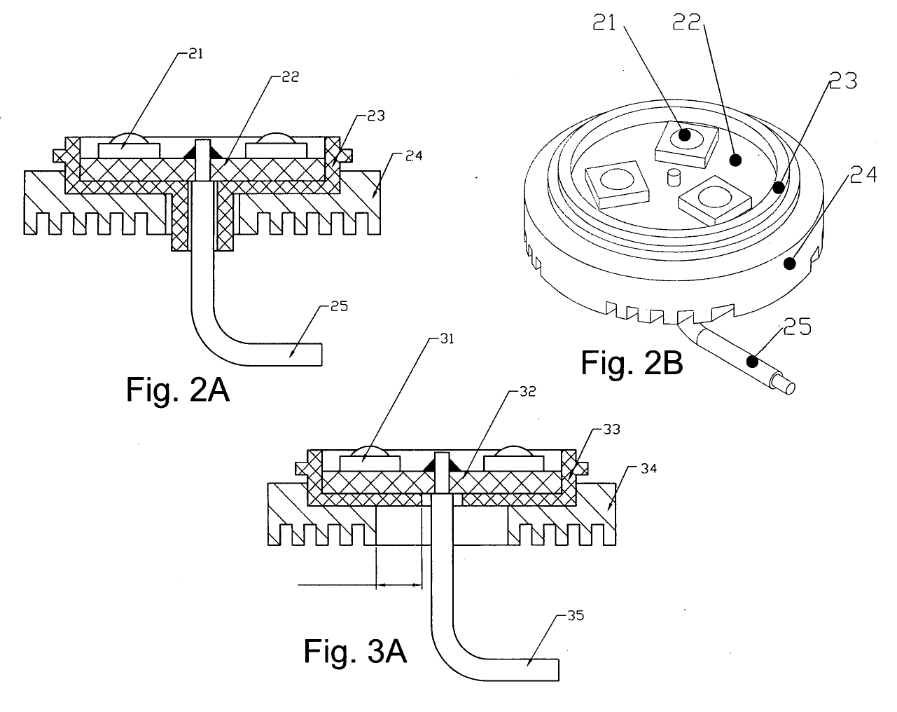

FIGS. 2A and 2B show a round light with the insulating housing 23. LEDs 21 are mounted on the PCB 22. The housing 24 is made of metal, such as aluminum, to dissipate the heat. The separator in this case is an insulating housing 23 installed between the PCB 22 and the housing 24. The insulating housing 23 goes through the hole on the bottom of the housing 24, through where the wires 25 connect to the PCB 22.

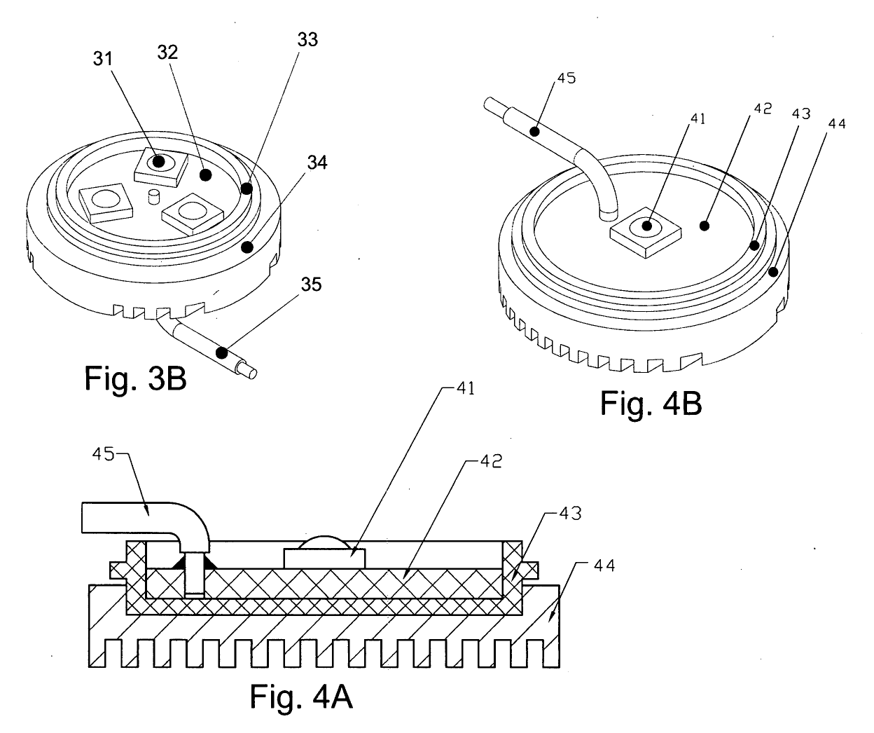

FIGS. 3A and 3B are similar to FIGS. 2A and 2B except that the separator in this case is an insulating housing 33 that does not go through the hole on the bottom of the housing 34. The insulating housing 33 has a hole on the bottom to let the wires 35 to go through to connect to the PCB 32. 3A refers to the distance between the edge of the hole on the bottom of the insulating housing and the edge of the hole on the bottom of the housing. This distance has to satisfy the related electrical requirements, such as the creepage distance.

FIGS. 4A and 4B show a LED round light. The separator in this case is an insulating housing 43 installed between the PCB 42 and the housing 44. The wires 45 connect to the PCB 42 on the top of the insulating housing 43. There is no hole on the insulating housing for the wires.

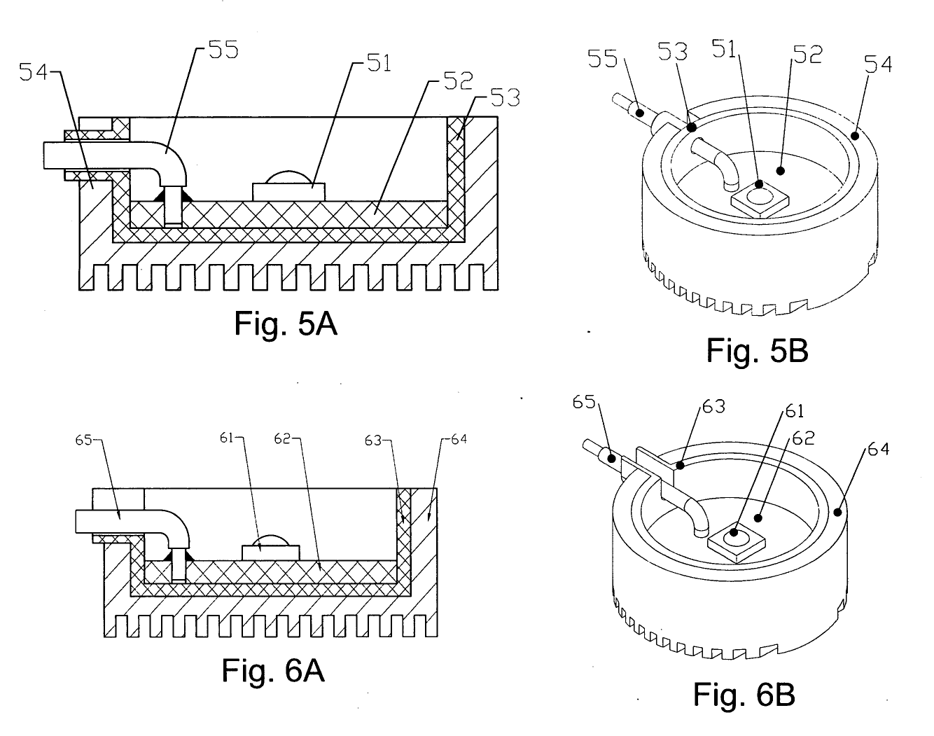

FIGS. 5A and 5B show a LED round light. The separator in this case is an insulating housing 53 installed between the PCB 52 and the housing 54. The insulating housing 53 goes through the hole on the side of the metal housing 54. The wires 55 connect to PCB 52 through the hole. Thus, this configuration shows an example with one or more openings extending through the channel, with one or more wires extending through the one or more openings, and the separator is configured to conform to the interior surface of the one or more openings and separate the wires from the housing.

FIGS. 6A and 6B show a LED round light. LEDs 61 are mounted on the PCB 62. The separator in this case is an insulating housing 63 installed between the PCB 62 and the housing 64. The insulating housing 63 has U-shape slot on the side going through the U-shape slot on the side of the housing. The wires 65 connect to the PCB 62 through this U-shape slot.

Each separator is made of one or more electrically insulating materials, at least functional as an electrical insulator relative to the housing. The separator is also thermally conductive, at least thermally conductive relative to air. In one embodiment, the separator should have thermal conductivity greater than or equal to 0.04 W/m° C. Suitable electrically insulating and thermally conductive materials include plastics, rubbers, semiconductor layers, silicones, fibreglasses, glasses, ceramic, oxidized compounds, polycarbonate, black lead and oxidized metals. In some embodiments, the separator has a maximum thickness between 0.1 to 3 mm thick, or an average thickness between 0.1 to 3 mm thick.

Immaterial modifications may be made to the embodiments described here without departing from what is covered by the claims. In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An LED lighting system, comprising:
a housing;
a circuit board carrying one or more LEDs; and
a separator between the housing and circuit board, the separator being electrically insulating relative to the housing and thermally conductive relative to air.

2. The LED lighting system of claim 1 in which the separator is thermally conductive relative to the housing.

3. The LED lighting system of claim 1 in which the separator conforms to the shape of the housing.

4. The LED lighting system of claim 3 in which the housing and separator each have the shape of a channel.

5. The LED lighting system of claim 1 in which the housing includes one or more openings extending through the channel, with one or more wires extending through the one or more openings, and the separator is configured to conform to the interior surface of the one or more openings and separate the wires from the housing.

6. The LED lighting system of claim 1 in which the separator has a maximum thickness between 0.1 and 3 mm thick.

7. The LED lighting system of claim 1 in which the separator has an average thickness between 0.1 and 3 mm thick.

8. The LED lighting system of claim 1 in which the separator has a thermal conductivity greater than or equal to 0.04 W/m° C.
